(19) United States
(12) Patent Application Publication
(10) Pub. No.: US 2004/0093750 A1
(43) Pub. Date: May 20, 2004

(54) Fluid instrument bearing

(76) Inventor: Ripley Quinby III, Ridgefield, CT (US)

Correspondence Address: Mr. Ripley Quinby III, 3 Mulberry Street, Ridgefield, CT, 06877, US

(21) Appl. No.: 10/298,716

(22) Filed: Nov. 18, 2002

(51) Int. Cl. G01C 17/08

(52) U.S. Cl. 33/364

(57) ABSTRACT

My invention, a fluid instrument bearing, which in one embodiment is constructed in the form of a magnetic compass, negates or greatly reduces the defects of the prior art by allowing the pole seeking magnet or magnets and associated indicia complete freedom of motion about all axes simultaneously, and by greatly reducing the pendulous effects of the prior art. At the same time, my invention is easy to construct and requires no frictional parts such as bearings. While this disclosure treats in its exemplary embodiment with the construction of a magnetic compass, it is to be understood that this invention deals with an essentially frictionless bearing or gimbal having complete freedom of motion about all axes simultaneously and as such is not limited only to its use in magnetic compasses, but will be of value whenever its unique properties and characteristics may be applicable.

### CROSS-REFERENCE TO RELATED APPLICATIONS

Not applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

Many instruments of measurement, control, navigation, and display require isolation from extraneous external influence of the sensing or mobile element as complete as may be contrived. My invention treats with an essentially frictionless instrument bearing having freedom to rotate about all axes simultaneously. Although the exemplary embodiment of my invention is disclosed in the form of a magnetic compass, it will be apparent as the disclosure proceeds that my invention is applicable wherever its unique properties may be of value.

As one example, the prior art of construction for a magnetic, pole seeking compass consists of one or a plurality of magnets, with an indicia, or compass card, affixed such that the pole seeking property of the magnet or magnets aligns the compass card allowing the user to determine the relative direction or bearing from the earth's local magnetic field.

The prior art generally utilizes a bearing, or bearings, typically of jeweled construction, upon which the compass card is pendulously suspended as a wheel upon a vertical axle, such bearing allowing free rotation of the magnet or magnets and the compass card about the horizontal plane. Reduced friction of the bearing and motional damping of the card is provided by immersing the card and bearing assembly in a fluid or liquid so as to provide lubrication of the bearing, reduction of the weight of the card and magnet assembly via buoyancy of same by the fluid or liquid, and utilization of the viscous properties of the fluid or liquid to provide damping of extraneous motions of the card.

A device constructed using the principals of the prior art yields a device with many drawbacks familiar to workers schooled in the art. The construction requires several small and expensive components; the various components must be finely balanced; the fluid or liquid must remain free of bubbles to prevent swirl of the damping fluid or liquid; and in particular the pendulous suspension of the magnet or magnets and the card leads to several unwanted effects when the instrument is used in a mobile environment, such as within an automobile, boat, or aircraft, due to the imperfect gimbaling of the magnet or magnets and card, and the lack of coincidence between the center of gravity of the magnet or magnets and card, and the center of buoyancy of same.

Specifically, the magnetic field of the earth is rarely parallel to the surface of the earth but attains an increasingly vertical component as the poles of the earth are approached. Because the prior art does not allow the pole seeking magnets total rotational freedom of motion, linear acceleration or deceleration of the instrument will cause the magnet or magnets and the attached indicia card to indicate a direction in error from that which would be apparent were the instrument not under linear acceleration. Furthermore, radial acceleration, or turning, from a given heading will cause the instrument to indicate a rate of turn lesser or greater than actual, depending upon the initial magnetic heading, such indications causing the instrument to lag or lead in its response to the turn.

Reference is made to U.S. Pat. No. 1,376,727 issued to Florence Lyon Pentu and James Bolton Pentu in 1921. In that invention, a compass, the active part is pendulously suspended within a chamber partially or completely filled with a buoyant liquid. In addition to being pendulously suspended, the active part is in physical contact with the interior surface of the container, giving rise to frictional errors.

Reference is also made to U.S. Pat. No. 1,754,055 issued to Frank G. Senter in 1930. In that invention, also a compass, the active part is suspended upon the interface between two immiscible liquids of differing specific gravity, with the active part being laterally constrained by a rigid axial member leading to all of the issues extant with pendulous restraint.

Reference is also made to the more general case of U.S. Pat. No. 2,765,541 issued to James K. Story in 1956. In that invention, an instrument float, an attempt is made to allow complete rotational freedom of motion of the float by constraining the lateral motion of the float strictly by the surface tension of the buoyant fluid. That invention is sensitive to its environment, and requires precisely manufactured and expensive components.

Reference is also made to U.S. Pat. No. 3,068,583 issued to Charles E. Goshen in 1962. In that invention, also a compass, the active part is again pendulously influenced by the interaction between the various parts. Additionally, that invention relies upon a delicate juxtaposition of its components to establish magnetic coupling. Such juxtaposition would be lost in an active environment, such as use of the invention aboard a ship or aircraft.

Reference is also made to the more general case of U.S. Pat. No. 3,286,358 issued to Jordan P. Smokowski in 1966. In that invention, an encased float, use is again made of the surface tension of the buoyant liquid, in that case a captive bubble, to constrain the float so as to prevent its contact with the container. That invention suffers from the same particulars as the Story patent referenced above.

Reference is also made to U.S. Pat. No. 3,373,498 issued to Henri Jules Chabbert in 1968. In that invention, also a compass, the active part is again forced to move pendulously by the action of the rolling part.

Reference is also made to U.S. Pat. No. 4,848,002 issued to Angel G. Carmona and Gregorio Martinez Gomez in 1989. That invention, also a compass, suffers from the same particulars as the Goshen patent referenced above.

### BRIEF SUMMARY OF THE INVENTION

One embodiment of my invention consists of an indicator, containing a magnet or magnets having north and south seeking poles at opposite ends, and in the case of a plurality of magnets, like seeking poles being arranged next to each other, and the major axes of such magnet or magnets being contained within the indicator so as to define a chord of maximal dimension through the indicator.

The center of gravity of the indicator containing the magnet or magnets is such that the indicator will float when immersed in a suitable liquid such that the magnet or magnets are essentially parallel to the surface of the earth, with the pole seeking ends of the magnet or magnets providing a rotational force to the indicator such that it will align with the local lines of the earth's magnetic field, and such that the indicator if disturbed will rotate about a horizontal axis so as to cause the indicator to float with one side preferentially up.

The indicator is contained within a outer shell, such that the indicator is detectable, visually or through other optical, magnetic, or electronic means through the outer shell and such that when the centers of the indicator and the outer shell are coincident there is no contact between the indicator and the outer shell.

The indicator is appropriately marked so that in viewing or sensing the various aspects of the indicator, the appropriate magnetic heading is visible or detectable. In the preferred embodiment, the indicia markings are arranged equatorially about the indicator so as to be easily viewed from the horizontal plane.

The interstitial space between the indicator and the outer shell is filled partially or completely with a suitable fluid or fluids having a density or densities such that the centers of the indicator and the outer shell are essentially coincident due to the buoyancy of the indicator when immersed in the fluid or fluids.

A multitude of small unconstrained spheres, or interstitial spacers, having a diameter approximately equal to the spacing between the indicator and the outer shell, are located within the outer shell, between the outer shell and the indicator. These interstitial spacers act only to prevent the indicator from contacting the interior surface of the outer shell in a lateral direction, and are not to be construed or regarded as bearings. In static conditions, the indicator is not in general contact with the interstitial spacers.

In dynamic conditions, such as when the invention is under linear or radial acceleration, the interstitial spacers and the indicator are free to react individually, and without interaction between themselves, to the resultant of the local gravitational vector and the local acceleration vector, yielding an essentially frictionless instrument with minimal pendulous indication effects.

In another embodiment of my invention, the indicator is of a shape such as a hemisphere, such that the indicia may be marked upon a planar surface essentially parallel to the surface of the earth allowing easy viewing from above.

In another embodiment of my invention, the outer shell is constructed of an opaque material and the orientation of the indicator is detected by external means familiar to those schooled in the art, such as Hall effect sensors fastened about two or more mutually exclusive axes with respect to the outer shell.

In another embodiment of my invention, the indicator orientation is determined by magnetic fields created by solenoid coils external to the outer shell. In that embodiment, my invention is a visual display of a three dimensional environment, such as the earth, its horizon, and the sky. In that embodiment, the indicator would be marked so as to represent the appropriate environment, rather than magnetic direction.

### BRIEF DESCRIPTION OF THE SEVERAL VIEWS OF THE DRAWING

FIG. 1 is a view of the three mutually orthogonal axes and their associated angles of rotation referenced in the disclosure.

FIG. 2 is a cross section view of one embodiment of my invention.

FIG. 3 is a cross section view of my invention across the section plane and in the direction labeled 3-3 in FIG. 2.

FIG. 4 is a perspective view of indicator 2 showing the relation of its various parts.

FIG. 5 is a perspective view of an alternate embodiment of an indicator suitable for viewing from above and showing the relation of its various parts.

FIG. 6 is an enlarged fragmentary view of the bottom or lower portion of FIG. 2.

### DETAILED DESCRIPTION OF THE INVENTION

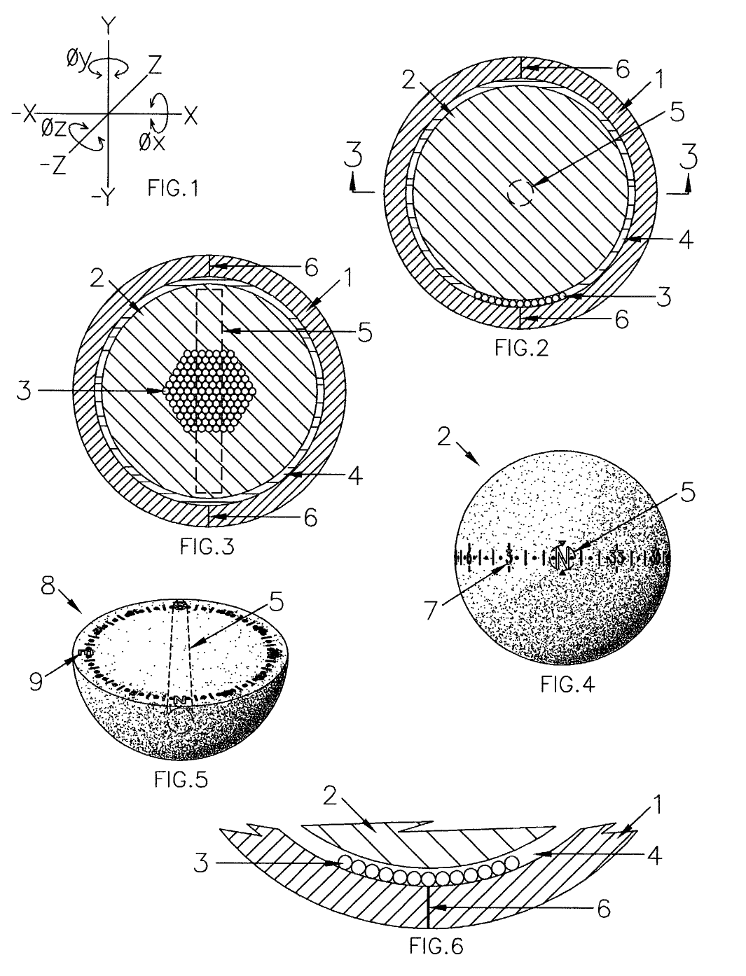

FIG. 1 is a view of the three mutually orthogonal axes and their respective angles of rotation as referred to in the disclosure, with the origin of the three axes located substantially at the center of gravity of indicator 2. Under static conditions, axis Y defines the direction known as vertical such that its extension would lead to the center of gravity of the earth, Y being defined as up and −Y being defined as down, and under dynamic conditions axis Y defines the center of the rotational angle φy known as yaw. Under static conditions, axis X defines the directions known as left and right, X being defined as right and −X being defined as left, and under dynamic conditions axis X defines the center of the rotational angle φx known as pitch. Under static conditions, axis Z defines the directions known as forward and backward, Z being defined as forward and −Z being defined as backward, and under dynamic conditions axis Z defines the center of the rotational angle φz known as roll. FIG. 2 is a cross sectional view of the fluid instrument bearing showing the outer shell 1, indicator 2, interstitial spacers 3, fluid filled interstitial volume 4, magnet 5, and hermetically sealed lubber line 6. FIG. 3 is a cross sectional view of the fluid instrument bearing taken in the plane and direction of 3-3 in FIG. 2 showing outer shell 1, indicator 2, interstitial spacers 3, fluid filled interstitial volume 4, magnet 5, and hermetically sealed lubber line 6. FIG. 4 is a perspective view of indicator 2 showing the arrangement of the indicia 7 and magnet 5 in the exemplary embodiment. FIG. 5 is a perspective view of an alternate embodiment of an indicator 8 suitable for viewing from above, and showing an alternate arrangement of the indicia 9 and magnet 5. FIG. 6 is an enlarged fragmentary view of the bottom or lower portion of FIG. 2 showing the detail of relation between indicator 2, outer shell 1, interstitial spacers 3, the fluid filled interstitial volume 4, and hermetically sealed lubber line 6.

In the exemplary embodiment indicator 2 is a solid sphere of homogeneous plastic material such as polyethylene or polypropylene. A cylindrical magnet 5 is firmly fixed in a hole machined through the center of indicator 2, and markings or indicia 7 representing the cardinal magnetic directions and as many subdivisions as may be desired are applied to the diameter of indicator 2 by appropriate means such as printing, laser etching, or engraving. In the exemplary embodiment indicator 2 is constructed such that it will float in a suitable fluid with indicia 7 and magnet 5 oriented horizontally in the plane defined by axes X and Z. In addition, indicia 7 are applied such that when magnet 5 orients indicator 7 with the earth's magnetic field, indicia 7 will indicate the magnetic heading when visually aligned with hermetically sealed lubber line 6. In the exemplary embodiment indicator 2 is 1.875 inches in diameter and magnet 5 is a rare earth magnet 0.0625 inches in diameter and 1.750 inches in length. It is important to understand that the center of gravity and the center of buoyancy of indicator 2 may be made arbitrarily close together, making my invention different from the prior art in its lack of pendulous responses due to this unique characteristic, in that indicator 2 is internally gimbaled about axes X, Y, and Z with complete freedom to rotate through the yaw, pitch and roll angles φy, φx, and φz respectively.

In the exemplary embodiment outer shell 1 is comprised of two identical hemispheres fabricated from a suitably rigid and transparent material such as glass, sapphire, or plastic such that when indicator 2 and interstitial spacers 3 are contained within outer shell 1, indicator 2 is easily visible, and the interstitial spacers 3 are free to roll on the interior surface of outer shell 1 without constraint. In the exemplary embodiment, outer shell 1 is glass 2.000 inches in inside diameter and 2.250 inches in outside diameter.

In the exemplary embodiment, interstitial spacers 3 are comprised of non-magnetic rigid spherical balls having a diameter equal to one half of the difference between the inside diameter of outer shell 1 and the diameter of indicator 2, are of a material of density such that they will not float in the fluid or fluids filling interstitial volume 4, and are of a quantity, not less than three, sufficient to prevent indicator 2 from contacting the inner surface of outer shell 1 when arranged as shown in FIG. 2 and FIG. 3. In the exemplary embodiment there are 127 spherical interstitial spacers 3 of non-magnetic type 316 stainless steel each having a diameter of 0.0625 inch.

In the exemplary embodiment, interstitial spacers 3 and indicator 2 are contained within outer shell 1. Outer shell 1 is then sealed at the mating surfaces of its two hemispheres as at hermetically sealed lubber line 6 using any suitable method familiar to workers schooled in the art, such as adhesive bonding or soldering, leaving a small hole in hermetically sealed lubber line 6 for the introduction of fluid or fluids to interstitial volume 4.

In the exemplary embodiment, transparent fluid or fluids is used to fill interstitial volume 4 providing buoyant support to indicator 2 so as to cause indicator 2 to float just out of contact with interstitial spacers 3. The fluid or fluids is introduced through the small hole remaining in hermetically sealed lubber line 6 on the mating edges of the two hemispheres comprising outer shell 1. In the exemplary embodiment, the interstitial volume 4 is filled using a small diameter hypodermic needle, and interstitial volume 4 is completely filled with a fluid having a density less than the density of indicator 2. Interstitial volume 4 is then further filled with a second fluid having a density greater than the density of indicator 2 and immiscible with the first fluid, such further filling displacing some of the first fluid so as to result in interstitial volume 4 being completely filled with fluid, the first fluid floating on the second fluid, and indicator 2 being buoyantly supported by the second denser fluid from being in substantial contact with interstitial spacers 3, as viewed in FIG. 6.

In the exemplary embodiment, the first fluid of lesser density is water white, acid free kerosene and the second fluid of greater density is perfluorinated ether. After interstitial volume 4 has been filled, the small hole used to introduce the fluids is sealed or plugged with any suitable material familiar to workers schooled in the art, such as adhesive bonding or solder, resulting in outer shell 1 being hermetically sealed. In use, hermetic sealed lubber line 6 is oriented vertically so as to be aligned with the plane defined by axes Y and Z. In such orientation, hermetically sealed lubber line 6 becomes a visible lubber line for purposes of sighting horizontally forward along the Z axis on indicia 7, as would be preferred when my invention is used in an aircraft or automobile.

In an alternate embodiment, indicator 2 is replaced by indicator 8 as shown in FIG. 5. In that embodiment, indicia 9 as shown in FIG. 5 are arranged peripherally about the horizontal planar surface of indicator 8, the alignment of indicia 9 and magnet 5 and the remaining details of assembly remaining substantially the same as in the exemplary embodiment. In the alternate embodiment, my invention is preferentially viewed from the top, or above along the Y axis, as would be preferred when my invention is used aboard a ship.

It will now be seen that my invention comprises an indicator 2 that has its center of gravity and center of buoyancy arbitrarily close together, and isolated from unwanted external influences by its complete suspension in a fluid filled interstitial volume 4. When the outer shell 1 of my invention is fastened to a vehicle, or held in the user's hand, with the hermetically sealed lubber line 6 appropriately oriented, indicator 2 will align itself with the earth's magnetic field so that the magnetic direction of the vehicle or user may be ascertained.

It is also now further seen that if the user or vehicle accelerates in any direction in the horizontal plane defined by axis Z and X, interstitial spacers 3 are free to move or roll about the origin of axes X, Y and Z such that the position of interstitial spacers 3 is a result of the vector sum of the earth's gravitational attraction and the acceleration applied. At the same time, it will be seen that indicator 2 will remain essentially horizontally situated due to its lack of pendulous response as its center of gravity and center of buoyancy may be made arbitrarily close together. These unique properties of my invention cause interstitial spacers 3 to automatically assume such orientation that they will prevent contact between indicator 2 and outer shell 1 during acceleration of my invention.

It is also now further seen that outer shell 1 may rotate about the origin of axes X, Y, and Z through angles φx, φy, and φz, either singly or simultaneously, and that interstitial spacers 3 will align themselves about the origin of axes X, Y, and Z such that interstitial spacers 3 always occupy the −Y, or down, direction during such rotation. At the same time, it will be seen that indicator 2 will remain essentially horizontally situated due to its lack of pendulous response as its center of gravity and center of buoyancy may be made arbitrarily close together. These unique properties of my invention causes interstitial spacers 3 to automatically assume such orientation that they will prevent contact between indicator 2 and outer shell 1 during rotation of my invention.

It is also now further seen that any combination of acceleration and rotation will cause interstitial spacers 3 to automatically assume such position that they prevent contact between indicator 2 and outer shell 1, while at the same time indicator 2 responds minimally to such acceleration and rotation because of the near coincidence of the center of gravity and center of buoyancy of indicator 2. These unique properties of my invention cause indicator 2 to maintain an essentially horizontal orientation with respect to the earth, and without undue external influence, resulting in minimized errors within indicator 2 due to the lack of pendulous response of indicator 2. My invention is therefore a fluid instrument bearing having internal gimbals that compensate for complete rotation and acceleration about all axes and angles of roll, pitch, and yaw simultaneously.

While this disclosure of my invention in its exemplary embodiment treats with the construction of a magnetic compass having unique properties, it is not to be construed that my invention is limited to such embodiment, nor to the dimensions or materials which are disclosed. My invention may be constructed of any materials and in any size such that its unique properties, being a fluid instrument bearing, are not impaired and may be of use.

I claim:

1) a fluid instrument bearing comprising:
(a) an outer shell having at least a portion of its interior surface in the shape of a spherical section and containing;
(b) an indicator having at least a portion of its exterior surface in the shape of a spherical section and having dimensions such that said indicator can be supported without contact with said outer shell in at least one orientation of said indicator with respect to said outer shell; and
(c) three or more interstitial spacers having a major dimension not larger than the dimension between said outer shell and said indicator when said indicator is supported without contact with said outer shell; said interstitial spacers being unconstrained in movement relative to themselves, said outer shell, and said indicator; and said interstitial spacers being contained within;
(d) an interstitial volume between said indicator and said outer shell partially or completely filled with one or more fluids serving to buoyantly support said indicator so as to prevent contact between said indicator and said outer shell;
(e) said interstitial volume between said indicator and said outer shell partially or completely filled with one or fluids serving to buoyantly support said indicator so as to substantially prevent contact between said indicator and said interstitial spacers.
